(19) United States
(12) Patent Application Publication
(10) Pub. No.: US 2026/0111329 A1
(43) Pub. Date: Apr. 23, 2026

(54) Methods, Systems and Computer-Readable Media for Testing Database Performance

(71) Applicant: Xero Limited, Te Aro, Wellington (NZ)

(72) Inventors: Geoff Thornburrow, Te Aro, Wellington (NZ); Caitlin Miller, Te Aro, Wellington (NZ)

(21) Appl. No.: 18/876,834

(22) PCT Filed: May 5, 2023
(86) PCT No.: PCT/NZ2023/050048

§ 371 Date: Dec. 19, 2024

(30) Foreign Application Priority Data
Jun. 20, 2022 (AU) 2022901675

(51) Int. Cl. G06F 11/34; G06F 16/242

(52) U.S. Cl. CPC G06F 11/3409; G06F 16/242; G06F 2201/80

(57) ABSTRACT

A method for conducting a performance test on a database system comprises receiving a plurality of configuration options. The configuration options determine parameters of the performance test to be conducted. The method further comprises retrieving organisation data from the database system to be tested, and performing a plurality of query operations on the database system. The plurality of query operations are based at least in part on the plurality of configuration options and the retrieved organisation data. The method further comprises recording database performance data based on the performance of the performed query operations.

### TECHNICAL FIELD

Embodiments relate to systems, methods, and computer-readable media for testing database performance. In particular, embodiments relate to systems, methods, and computer-readable media for conducting performance tests on databases.

### BACKGROUND

When working with data within a database structure, it is often necessary to perform various operations on the data. For example, it may be necessary to query the data in various ways, such as to read certain entries of the database. While performing queries may be relatively straightforward on small databases, the larger the database the more computationally intensive it becomes to perform a read query.

Furthermore, certain database architectures may add complexity to performing queries. For example, a database may be sharded across multiple database servers. This results in increased latency when performing queries, especially where multiple shards of the database are to be searched. Furthermore, multi-tenanted databases may provide further complications when it comes to running a query, as the database may still need to be accessible to other tenants while the query is being performed.

It is desirable to conduct performance tests on databases to determine and prevent potential load issues prior to them occurring unexpectedly while the database is deployed for use to an end user. Performance testing is used to test a databases performance, reliability, and scalability under load, and may help to identify bottlenecks and points of contention within a database. However, conducting performance tests on the aforementioned database configurations utilising existing solutions generally results in non-realistic load behaviour and a poor indication of future or potential performance.

It is desired to address or ameliorate one or more shortcomings or disadvantages associated with prior systems, methods, and computer-readable media for performing database performance tests, or to at least provide a useful alternative hereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method for conducting a performance test on a database system, the method comprising: receiving a plurality of configuration options, the configuration options determining parameters of the performance test to be conducted; retrieving organisation data from the database system to be tested; performing a plurality of query operations on the database system, the plurality of query operations being based at least in part on the plurality of configuration options and the retrieved organisation data; and recording database performance data based on the performance of the performed query operations.

In some embodiments, the configuration options include at least one query to be executed and at least one frequency at which the query is to be executed. According to some embodiments, performing a plurality of query operations on the database system comprises identifying whether at least one query is scheduled to be performed based on the at least one frequency, and upon determining that at least one query is scheduled to be executed, executing the query. Some embodiments further comprise, upon determining that no queries are scheduled to be executed, causing a thread to sleep for a predetermined duration.

In some embodiments, the organisation data comprises data related to an amount of data stored by an organisation in the database being queried. According to some embodiments, the organisation data comprises data related to a rank of the organisation based on the amount of data stored by the organisation in the database being queried. In some embodiments, at least two of the plurality of query operations are performed simultaneously. In some embodiments, the database system is a sharded database and the method is performed for each shard. According to some embodiments, the plurality of query operations are the same.

In some embodiments, the plurality of query operations are performed repeatedly at the same frequency. In some embodiments, the plurality of query operations are performed at varying frequencies. According to some embodiments, the plurality of configuration options are retrieved from an SQL file. Some embodiments further comprise, after receiving the plurality of configuration options, validating the plurality of configuration options. In some embodiments, validating the plurality of configuration options comprises checking that at least one query has been received. According to some embodiments, validating the plurality of configuration options comprises checking that at least one frequency has been received. Some embodiments further comprise: storing a plurality of overdue query operations in a backlog; and wherein the stored plurality of overdue query operations are prioritised.

Some embodiments relate to a device comprising: a memory storing executable code; a processor configured to access memory to execute the executable code; and wherein when executing the executable code, the processor is caused to perform the method of one or more of the described embodiments.

Some embodiments relate to a computer-readable storage medium storing instructions that, when executed by a processor, cause the processor to perform the method of one or more of the described embodiments.

### BRIEF DESCRIPTION OF DRAWINGS

Various ones of the appended drawings merely illustrate example embodiments of the present disclosure and cannot be considered as limiting its scope.

FIG. 1 is a schematic diagram of a system for conducting database performance tests, according to some embodiments;

FIG. 2 is a schematic illustration of available settings for conducting database performance tests, according to some embodiments;

FIG. 3 is a schematic illustration of output data as a result of conducting database performance tests, according to some embodiments; and

FIG. 4 is a process flow diagram of a method for performing database performance tests, according to some embodiments.

### DESCRIPTION OF EMBODIMENTS

The database operations of the described embodiments may comprise technology and methods described in Provisional Application No. AU2022/900112 filed 21 Jan. 2022 and titled “Methods and systems for performing database operations”, the contents of which are hereby incorporated by reference.

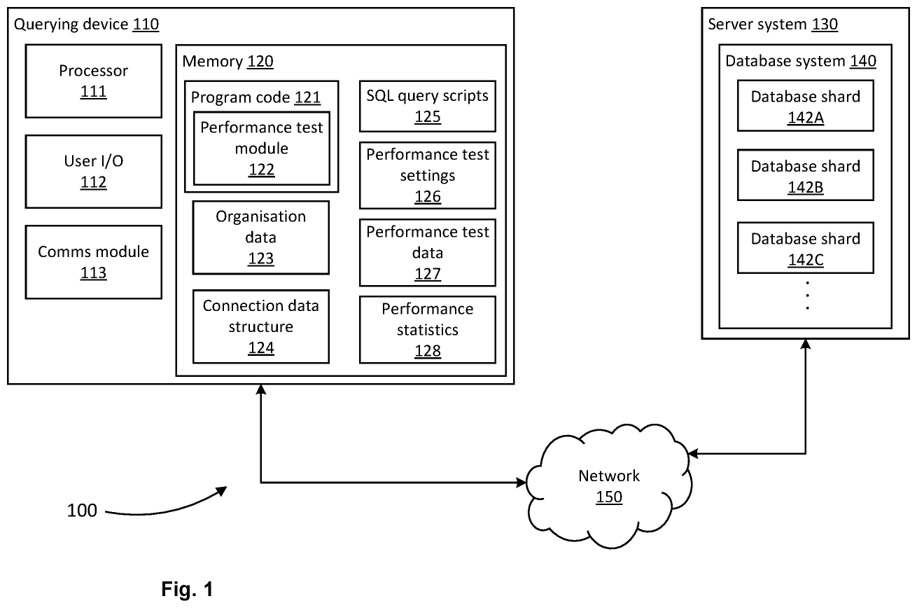

FIG. 1 is a block diagram of a system 100 for performing database operations. System 100 comprises a querying device 110 and a server system 130 accessible to querying device 110 via a network 150. Server system 130 stores a database system 140 configured to be queried by querying device 110. While the illustrated embodiment shows querying device 110 as independent of server system 130, according to some embodiments one or more parts of these devices and systems may be integrated. For example, according to some embodiments, querying device 110 may form part of server system 130.

Querying device 110 comprises a processor 111 in communication with a memory 120. Processor 111 comprises one or more data processors for executing instructions, and may comprise one or more microprocessor based platforms, central processing units (CPUs), application specific instruction set processors (ASIPs), application specific integrated circuits (ASICs), suitable integrated circuits, or other processors capable of fetching and executing instruction code as stored in memory 120. Processor 111 may include an arithmetic logic unit (ALU) for mathematical and/or logical execution of instructions, such as operations performed on data stored in internal registers of processor 111.

Memory 120 may comprise one or more memory storage locations, which may be volatile or non-volatile memory types. For example, memory 120 may comprise one or more of random access memory (RAM), read-only memory (ROM), electrically erasable programmable read-only memory (EEPROM) or flash memory. Memory 120 is configured to store program code 121 accessible by the processor 111. Program code 121 may comprise a plurality of executable program code modules executable by processor 111 to cause processor 111 to perform functions as described in further detail below. For example, program code 111 may comprise a performance test module 122 which, when executed, may cause processor 111 to conduct a performance test on database system 140. According to some embodiments, separate instances of performance test module 122 may be executed for every shard of database system 140 that is to be performance tested. In some embodiments, performance test module 122 is configured to perform either a “stress test runner” test or a “scheduled runner” test, for example. A “stress test runner” test is a flat stress test, where a single script is repeatedly run to query database system 140. A “scheduled runner” test is a dynamic stress test, where various scripts are run at different times and frequencies to query database system 140, resulting in a more realistic simulation of natural querying behaviour of users of the database system 140.

Memory 120 may also comprise one or more data files comprising data that is accessible to processor 111 for performing read and write functions. For example, memory 120 may store organisation data 123, a store of tenant (organisation) identifications (IDs), and/or past queries executed by tenants, and/or data use statistics with respect to database system 140, or in some embodiments an alternate database. In some embodiments, organisation data 123 may be configured to store data accessible and usable by performance test module 122 when executed by processor 111. In some embodiments, organisation data 123 is retrieved from database 140 by performance test module 122 when executed by processor 111. When retrieved, the tenant IDs are ranked according to a heuristic that estimates the amount of data, in the database 140, allocated to each tenant. That is, the tenant IDs are ranked by size, in terms of the amount of data associated with the tenant on database system 140.

SQL query scripts 125 may be configured to store data accessible and usable by performance test module 122 when executed by processor 111. SQL query scripts 125 may include a plurality of SQL queries ready to be executed by processor 111 to query database system 140. In some embodiments, the SQL queries included in SQL query scripts 125 may require a tenant ID as an input.

Performance test settings 126 may be configured to store configuration data usable to control performance test module 122. Performance test settings 126 may be used by processor 111 when executing performance test module 122 to determine the configuration of the performance test being run on database system 140. That is, performance test settings 126 may be used to configure performance test settings of performance test module 122 when executed by processor 111, for example.

Performance test data 127 may be configured to store output data of performance test module 122 when executed by processor 111. In some embodiments, performance test data 127 may be in the form of a comma-separated values (CSV) file. In some embodiments, there may be a plurality of performance test data 127 with unique file names, one for every test performed by performance test module 122.

Performance statistics 128 may be configured to store output data of performance test module 122 when executed by processor 111. In some embodiments, performance statistics 128 may comprise data relating to the performance of query device 110, database system 140, and/or network 150, such as CPU usage, memory usage, queries per second, data read/write, or network statistics, for example. In some embodiments, performance statistics 128 may comprise time-series data of database system 140 performance metrics. In some embodiments, performance statistics 128 may be in the form of a CSV file. In some embodiments, there may be a plurality of performance test data 128 with unique file names, one for every test performed by performance test module 122.

Querying device 110 may also comprise user input and output (I/O) 112 capable of receiving inputs, such as queries, from one or more users of querying device 110, and capable of conveying outputs, such as information, to the user. User interface 112 may comprise one or more user interface components, such as one or more of a display device, a touch screen display, a keyboard, a mouse, a camera, a microphone, and buttons, for example. In some embodiments, the configuration options of performance test settings 126 may be input directly by a user via user I/O 112 when prompting processor 111 to execute performance test module 122. In some embodiments, user I/O 112 may be used to display database performance test results stored in performance test data 127, for example.

Querying device 110 may further comprise a communications module 113 configured to facilitate communication between querying device 110 and one or more external computing devices via one or more networks. Communications module 113 may comprise a combination of network interface hardware and network interface software suitable for establishing, maintaining and facilitating communication over a relevant communication channel. According to some embodiments, communications module 113 may facilitate communication between querying device 110 and other devices within system 100 via network 150. For example, communications module 113 may facilitate communication between querying device 110 and server system 130.

Network 150 may comprise one or more local area networks or wide area networks that facilitate communication between elements of system 100. For example, according to some embodiments, network 150 may be the internet. However, network may comprise at least a portion of any one or more networks having one or more nodes that transmit, receive, forward, generate, buffer, store, route, switch, process, or a combination thereof, etc. one or more messages, packets, signals, some combination thereof, or so forth. Network 150 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, or some combination thereof.

Server system 130 may comprise one or more computing devices and/or server devices, such as one or more servers, databases, and/or processing devices in communication over a network, such as database system 140, for example. Database system 140 may comprise one or more data storage locations comprising a data structure. In some embodiments, database system 140 may be an SQL server, for example. According to some embodiments, database system 140 may comprise a sharded database, wherein shards of database system 140 are stored individually. According to some embodiments, shards of database system 140 may be stored in different physical locations. According to some embodiments, database system 140 may comprise a plurality of individual database shards 142 making up the database structure. Each database shard 142 may comprise one or more data entries accessible to server system 130 for read and write operations. While the illustrated embodiment shows three database shards 142A, 142B and 142C, this is illustrated as an example only and any number of database shards 142 may exist within database system 140.

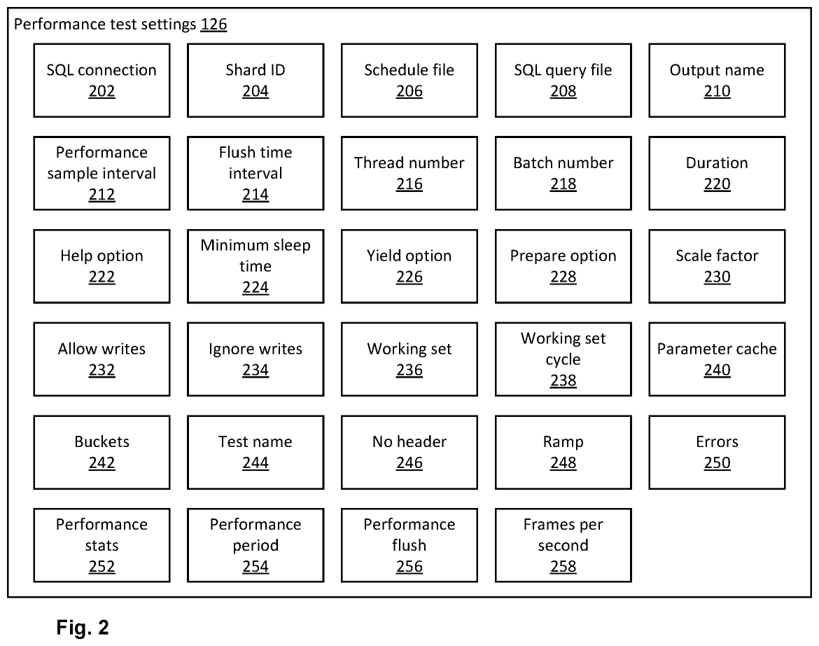

FIG. 2 shows a plurality of performance test settings 126, according to some embodiments. In some embodiments, performance test settings 126 may comprise at least a subset of the shown data values in FIG. 2. That is, performance test settings 126 may comprise data values associated with one or more of an SQL connection 202, shard ID 204, schedule file 206, SQL query file 208, output name 210, performance sample interval 212, flush time interval 214, thread number 216, batch number 218, duration 220, help option 222, minimum sleep time 224, yield option 226, prepare option 228, scale factor 230, allow writes 232, ignore writes 234, working set 236, working set cycle 238, parameter cache 240, buckets 242, test name 244, no header 246, ramp 248, errors 250, performance stats 252, performance period 254, performance flush 256, and frames per second (FPS) 258, for example.

SQL connection 202 may comprise a value identifying a database shard 142 to be tested. For example, SQL connection 202 may comprise an SQL connection string indicating the database shard 142 to be tested.

Shard ID 204 may comprise a shard ID value indicating a specific shard to be tested, such as database shard 142A, for example.

Schedule file 206 may comprise information relating to the scripts or queries to be executed during a performance test. For example, schedule file 206 may comprise a path to and/or a filename to a file containing a list of scripts to be run, a frequency at which scripts are to be executed, and an optional timeout duration. In some embodiments, if schedule file 206 is within the same memory location as performance test module 122 then only the filename is required. The frequency in the schedule file 206 may indicate the frequency at which the one or more scripts in the list of scripts are to be executed by processor 111. For example, the schedule file 206 may indicate that 50 scripts are to be executed per second. The timeout duration in the schedule file 206 may indicate the maximum time the list of scripts is to be executed by processor 111 before being cancelled or skipped, for example. According to some embodiments, schedule file 206 may comprise a single frequency, an optional timeout duration, and a list of scripts. In some alternative embodiments, each line in schedule file 206 may comprise a frequency or start time, a filename of a script to run, and an optional timeout duration. In some embodiments, the frequency may be in the form of a number indicating the intervals, in milliseconds, at which to run the script specified in the filename. The frequency may be a start time in the form of a 24 hour system comprising hours, minutes, and seconds, for example. The filename of schedule file 206 may be in the form of the name of an SQL file including the ‘.sql’ extension, such as ‘example.sql’, for example. The timeout duration may be in the form of a number indicating the duration for which the processor 111 is to execute the script specified in the particular line before timing out.

SQL query file 208 may comprise a path to and/or a filename to an SQL file containing a single SQL query script to be run. In some embodiments, if the SQL query file 208 is within the same memory location as performance test module 122 then only a filename is required. The filename of SQL query file 206 may be in the form of the name of an SQL file including the ‘.sql’ extension, such as ‘example.sql’, for example. In some embodiments, if the schedule file 206 setting is used, the SQL query file 208 setting is omitted and vice versa. That is, if a user wishes to run a “scheduled runner” test the schedule file 206 setting will be used. If a user wishes to run a “stress test runner”test the SQL query file 208 setting will be used.

Output name 210 may comprise a string file name for a file into which performance test data 127 may be recorded. If output name 210 comprises a predetermined value corresponding to an automatic file name generation such as the string value “auto”, for example, a unique file name including a current timestamp will be generated, such as “20220225_0305_default.csv”, for example. In some embodiments, output name 210 may only be required when utilising the schedule file 206 setting for a “scheduled runner” test. In some embodiments, a user may define a string file name for output name 210 in the form of a string value, for example.

Performance sample interval 212 may comprise a data value indicating the desired time between query performance samples. According to some embodiments, performance sample interval 212 may comprise a data value indicating the desired time in milliseconds, such as “1000”, for example.

Flush time interval 214 may comprise a data value indicating the desired time between flushes of performance test data 127 outputs. According to some embodiments, flush time interval 214 may comprise a data value indicating the desired time between flushes of performance test data 127 in seconds, such as “10”, for example.

Thread runner 216 may comprise a data value indicating the number of threads for the performance test to use, such as “4”, for example.

Batch number 218 may comprise a data value indicating the number of query batches to run. In some embodiments, batch runner 218 may only be required when utilising the SQL query file 208 setting for a “stress test runner”test.

Duration 220 may comprise a data value indicating a time, in seconds, for the performance test module 122 to run.

Help option 222 may, when enabled or input by a user, show a help page. In some embodiments, the help page may provide the user with instruction on using the performance test module 122, and/or answers to commonly asked questions.

Minimum sleep time 224 may comprise a data value indicating the amount of time a thread should sleep if it is told by processor 111 that there is nothing to do. According to some embodiments, minimum sleep time 224 may comprise a data value indicating the amount of time a thread should sleep in milliseconds. In some embodiments, a minimum sleep time 224 value of “0” will yield processor 111 to the next waiting thread, for example. A minimum sleep time 224 value greater than zero will sleep the thread for that duration. In the case that a “stress test runner” test is being conducted, the minimum sleep time 224 indicates the minimum duration to sleep after running a query.

Yield option 226 may comprise a data value instructing the processor 111 to yield a thread after each execution (unless already sleeping) when conducting a “stress test runner”test.

Prepare option 228 may comprise a data value instructing processor 111 to compile, prior to execution, the SQL command when conducting a “stress test runner” test.

Scale factor 230 may comprise a data number value indicating a frequency factor in which to run the scripts contained in schedule file 206. That is, the number value of scale factor 230 may be used to scale the frequencies contained within schedule file 206 to increase or decrease the frequency in which they are run. For example, a scale factor 230 of ‘0.5’ would run the scripts half as quickly, a scale factor 230 of ‘1’ would run the scripts at a normal speed, and a scale factor 230 of ‘2’ would run the scripts twice as quickly. In some embodiments, scale factor 230 may be used to scale working set 236.

Allow writes 232 may comprise a data value indicating whether query module 122 is allowed to load/execute data-modifying queries. For example, a value of “1” stored in allow writes 232 may indicate that query module 122 is allowed to execute data-modifying queries. In some embodiments, allow writes 232 will be executed prior to schedule file 206.

Ignore writes 234 may comprise a data value indicating whether query module 122 is to ignore data-modifying queries. For example, a value of “1” stored in ignore writes 232 may indicate that query module 122 is not to load or execute data-modifying queries. In some embodiments, ignore writes 234 will be executed prior to schedule file 206. According to some embodiments, when conducting a “scheduled runner” test, either allow writes 232 or ignore writes 234 must be specified in performance test settings 126 for processor 111 to execute performance test module 122.

Working set 236 may comprise a data value indicating the number of tenant IDs, or organisation parameters, stored in organisation data 123, to be made available to performance test module 122 when executing queries on database system 140. In some embodiments, working set 236 may be used to simulate active tenant workload on database system 140.

Working set cycle 238 may comprise a data value indicating a time between cycling the set of organisation parameters as described above. According to some embodiments, working set cycle 238 may comprise a data value in seconds. A time between cycling the set of organisation parameters may be the time between selecting a range of organisation IDs from the set of available organisation IDs in organisation data 123 and then selecting a new range of organisation IDs from the set of available organisation IDs in organisation data 123, for example.

Parameter cache 240 may comprise a path to and/or a filename to a file containing the parameter cache as described in relation to working set 236. In some embodiments, if the parameter cache 240 file is within the same memory location as performance test module 122 then only a filename is required. In some embodiments, parameter cache 240 may be stored in organisation data 123.

Buckets 242 may comprise a data value indicating a value to be used to quantize the size ranking of the retrieved tenant IDs described in relation to parameter cache 240. Specifically, buckets 242 may hold a value indicating the number of groupings or data ‘buckets’ into which to place the retrieved tenant IDs. For example, the buckets 242 value may be set to ‘100’ in order to give percentiles of tenants by size, where a buckets 242 value of ‘100’ denotes 100 data buckets. If a particular data point is in bucket 40 of the 100, then if the buckets 242 value were ‘50’ that particular data point would be in bucket 20 of the 50 buckets if using the same data set, for example. In some embodiments, query statistics obtained when executing performance test module 122 may be aggregated against the percentile bucket belonging to the tenant for the particular query run. In some embodiments, the parameter cache 240 setting is required for the buckets 242 setting to be used.

Test name 244 may comprise a data string value indicating a desired name of the performance test to be run. Test name 244 will be recorded in performance test data 127. In some embodiments, the default value of test name 244 is “default”. In some embodiments, a user may specify a data string value for test name 244, such as “Test 123”, for example.

No header 246 may comprise a data value indicating for performance test module 122, when executed by processor 111, to not include a CSV header row in the output performance test data 127. For example, a value of “1” stored in no header 246 may indicate that no header row is to be included.

Ramp 248 may comprise a data value indicating a number amount by which to change scale factor 230 each second. That is, the ramp 248 value is added to the scale factor 230 each second that the performance test is being conducted. In some embodiments, ramp 248 may be used to generate a ramp-up period in the test, allowing a dynamic simulation of varying user loads, for example.

Errors 250 may comprise a data string value indicating the desired name of a file to output errors to.

Performance stats 252, may comprise a data value indicating the desired name of a performance statistics 128 file containing output performance statistics related to database system 140 when conducting a “scheduled runner”test.

Performance period 254 may comprise a data value indicating a time period between performance samples when conducting a “scheduled runner” test. That is, performance period 254 indicates the time between sampling available performance statistics as described in relation to performance statistics 128, for example. When performance statistics 128 are sampled, they are buffered, or stored temporarily, in memory 120. According to some embodiments, performance period 254 may comprise a data value indicating a time period in seconds.

Performance flush 256 may comprise a data value indicating a time period between flushes of the sampled performance statistics 128 when conducting a “scheduled runner” test. That is, for every flush, or time period as indicated by performance flush 256, the sampled performance statistics 128 that are buffered, or stored temporarily, are written to the file outlined in performance stats 252. This may assist in reducing loss of performance statistics should performance test module 121 be terminated early or unexpectedly. According to some embodiments, performance flush 256 may comprise a data value indicating a time period in seconds.

Frames per second (FPS) 258 may comprise a data value indicating the number of FPS to refresh a user interface displayed on user I/O 112. That is, if user I/O 112 comprises a display device, FPS 258 indicates the frequency at which consecutive images of the user interface are displayed, for example.

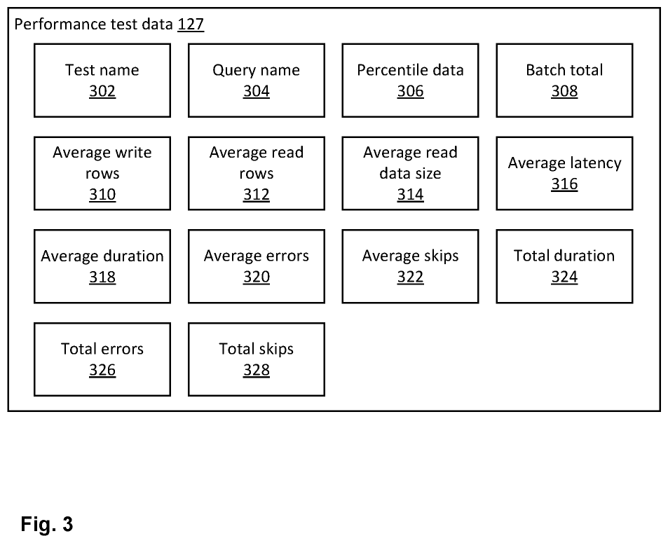

FIG. 3 shows a plurality of possible output data that may be generated by executing performance test 122, according to some embodiments. According to some embodiments, performance test data 127, may comprise at least a subset of the shown data values. That is, performance test data 127 may comprise data values associated with at least one of a test name 302, query name 304, percentile data 306, batch total 308, average write rows 310, average read rows 312, average read data size 314, average latency 316, average duration 318, average errors 320, average skips 322, total duration 324, total errors 326, and total skips 328, for example. In some embodiments, performance test data 127 may be sorted by query type.

Test name 302 may comprise a data string value indicating the name of the particular test run being conducted. Test name 302 is obtained via the data value test name 246 of performance test settings 216. In some embodiments, if test name 246 is not entered or used, test name 302 may be set to a default value, such as “default”.

Query name 304 may comprise a data string value indicating the name or type of query script that the particular data output relates to. In some embodiments, performance test data 127 may include multiple data outputs in the one file, relating to multiple query scripts, for example. In some embodiments, the data value of query name 304 may be obtained from the list of scripts contained within schedule file 206 when conducting a “scheduled runner” test, for example. In some embodiments, the data value of query name 304 may be obtained from the script contained within SQL query file 208 when conducting a “stress test runner”test, for example.

Percentile data 306 may comprise a data value indicating a percentile value for which test data corresponding to organisations within this percentile is recorded under. For example, a percentile value of ‘0’ would indicate that the output data relates an organisation, or organisations, of which no other organisations are smaller in size, or the smallest organisation(s). For example, a percentile value of ‘50’ would indicate that the output data relates an organisation, or organisations, of which 50% of the organisations stored in organisation data 123 are smaller in size, in terms of amount of data.

Batch total 308 may comprise a data value indicating the number times the script, as indicated by query name 304, was scheduled to be executed by processor 111. In some embodiments, this data value may include the total sum of the number of successful and aborted executions of the particular query. That is, batch total 308 is the total number of all successful and aborted, due to an error or a skip, executions of the script indicated by query name 304, for example.

Average write rows 310 may comprise a data value indicating the average number of rows written per batch of queries executed by processor 111.

Average read rows 312 may comprise a data value indicating the average number of rows read per batch of queries executed by processor 111.

Average read data size 314 may comprise a data value indicating the average amount of data returned from each query executed by processor 111. According to some embodiments, average read data size 314 may comprise a data value indicating the average amount of data returned in bytes. In some embodiments, average read data size 314 may be recorded by query name 304 and/or tenant percentile bucket.

Average latency 316 may comprise a data value indicating the average time spent in I/O per batch when executed by processor 111. That is, average latency 316 is the average time between processor 111 executing a query to database system 140 and the first result being returned.

Average duration 318 may comprise a data value indicating the total time spent, by processor 111, executing a batch of queries.

Average errors 320 may comprise a data value indicating the average number of errors raised per batch. In some embodiments, when an error is raised, the batch being executed by processor 111 will end. That is, the value of average errors 320 may be either a ‘0’ or a ‘1’, for example.

Average skips 322 may comprise a data value indicating the average number of skips raised per batch. In some embodiments, when a skip is raised, the batch being executed by processor 111 will end. That is, the value of average skips 322 may be either a ‘0’ or a ‘1’, for example. In some embodiments, a batch or queries will be skipped if it is determined that the tenant does not have enough information to complete the desired script. For example, if a tenant attempts to execute a ‘pay invoice’ script without having any invoices, the batch being executed by processor 111 will skip.

Total durations 324 may comprise a data value indicating the total time spent by processor 111 executing batches relating to the script indicated by query name 304.

Total errors 326 may comprise a data value indicating the total number of errors to occur when executing batches relating to the script indicated by query name 304.

Total skips 328 may comprise a data value indicating the total number of skips to occur when executing batches relating to the script indicated by query name 304.

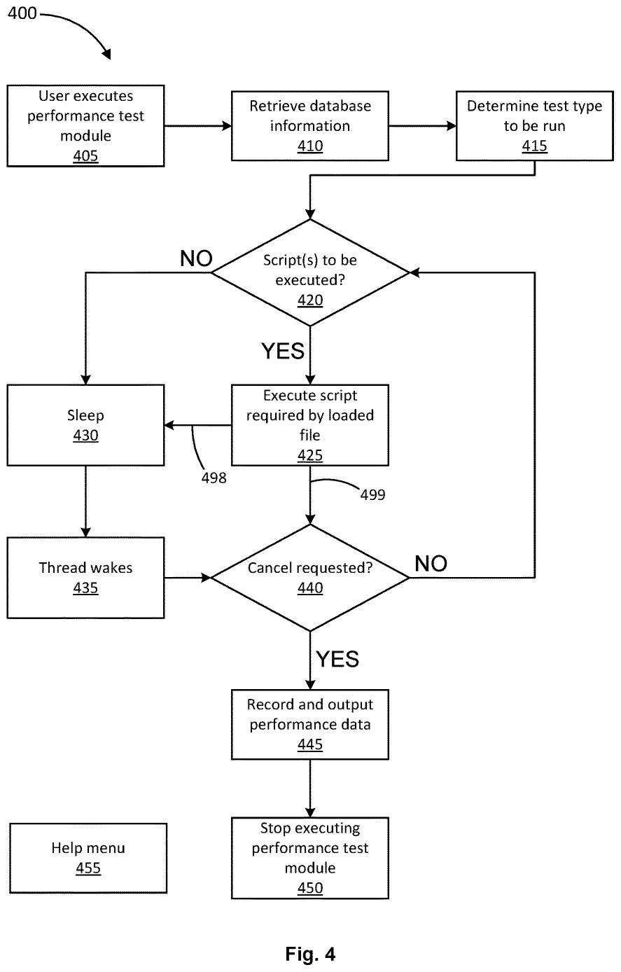

FIG. 4 is a process flow diagram of a method 400 performed by processor 111 of querying device 110 when caused to execute program code 121, and specifically performance test module 122. Method 400 relates to a method for conducting performance tests on database system 140. According to some embodiments, processor 111 may be caused to execute performance test module 122 when a user input is received by user I/O 112 indicating that a user of querying device 110 wishes to conduct a performance test on database system 140. According to some embodiments, the desired one or more performance tests and the required configurations may be input by the user using user I/O 112, and stored by processor 111 in performance test settings 126. According to some embodiments, processor 111 may be caused to execute an instance of performance test module 122 for each database shard 142 in database system 140.

At step 405, processor 111 commences executing performance test module 122 as directed by a user input. In some embodiments, the user input may be in the form of a command line containing some, or all, of the configuration settings as described in relation to FIG. 2 as a manual input, for example. In some embodiments, the user input may be in the form of a command to execute an executable file containing the configuration settings of performance test settings 126, for example. In some embodiments the configurations settings of performance test settings 126 are modified prior to receiving the user input. In some embodiments, processor 111, upon executing performance test module 122, will validate the provided configuration settings. If any validation rules are broken, processor 111 will provide an error message to the user via user I/O 112. Some example validation tests may include: determining whether SQL connection 202 is populated; in a “stress test runner” test determining whether at least one query is provided in SQL query file 208; determining whether the value of thread number 216 is between 1 and 100, inclusive; and determining whether either SQL query file 208 or schedule file 206 has been provided, for example.

At step 410, processor 111 communicates with database system 140, via network 150 via communications module 113, to retrieve organisation data 123. At this step, database system 140 is determined by the configuration settings, particularly SQL connection 202. In some embodiments, a shard ID 204 may be provided when executing performance test module 122, identifying a specific database shard 142 of database system 140 to run the performance test on. From organisation data 123, processor 111 may generate parameter cache 240. In some embodiments, the parameter cache is quantized according to buckets 242.

At step 415, processor 111 executing performance test module 122 determines, via the performance test settings 126, whether to run a “stress test runner” test or a “scheduled runner” test. Processor 111 determines this dependent on the type of file specified in performance test settings 126, either a schedule file 206 (‘scheduled runner’) or an SQL query file 208 (‘stress test runner’). In some embodiments, if processor 111 determines that the file specified is neither a schedule file 206 nor an SQL query file 208, method 400 will end. In some embodiments, if method 400 ends due to an error, a message will be displayed to the user with information pertaining to the type of error that has occurred.

Upon determining that either a “stress test runner” test or a “scheduled runner” test is to be performed, processor 111, at step 415, accesses either the schedule file 206 or the SQL query file 208 via the provided path to and/or filename as described in relation to FIG. 2, prior to moving to step 420. At step 420, processor 111 will determine whether queries from the accessed file are to be executed. Where a “stress test runner” test is being performed, processor 111 may always determine that there are queries to be executed. Where a “scheduled runner” test is being performed, processor 111 may determine whether there are queries to be performed based on the frequency defined in the schedule file 206. For example, where the frequency is 50 queries a second and only 30 queries have been performed since the last second elapsed, processor 111 may determine that there are queries to be performed. Where the frequency is 50 queries a second and 50 queries have already been performed since the last second elapsed, processor 111 may determine that there are no queries to be performed.

In some embodiments, queries from schedule file 206 may be placed in a backlog while other steps of method 400 are being executed or if they are overdue. For example, if processor 111 is executing another step of method 400, such as step 430, and a scheduled query in schedule file 206 is to be executed at the current time it may be added to a backlog. If the required frequency of scheduled queries is 50 queries a second and only 30 queries have been performed and the second elapses, 20 queries may be placed in the backlog. Processor 111, upon returning to method 420, will determine based on the backlog and the schedule file 206 whether queries exist in the backlog waiting to be executed. Processor 111 may execute a plurality of queries contained within the backlog and the schedule file 206 simultaneously, for example. In some embodiments, processor 111 may prioritise queries contained within the backlog.

If processor 111 determines at step 420 that no scripts are to be executed at the current time, processor 111 will move to step 430.

If processor 111 determines at step 420 that there are scripts to be performed, processor 111 may check if any processing threads are available up to the maximum specified by the value in thread number 216. If no threads are currently available, processor 111 will move to step 430. In some embodiments, processing threads will become available once a previously executed query is completed, or the duration for which a query is specified to run for has expired, for example. If a processing thread is determined to be available, processor 111 will move to step 425.

At step 430, threads of processor 111 may sleep for a time specified in minimum sleep time 224 prior to moving to step 435. For example, in a “stress test runner” test the minimum sleep time 224 indicates the minimum time between processor 111 executing the script and processor 111 moving to step 435. At step 435, the threads of processor 111 wake up and processor 111 moves to step 440.

At step 425, processor 111 will execute queries as required by schedule file 206 or SQL query file 208. That is, upon accessing an SQL query file 208, processor 111 will execute the single SQL query script stored in SQL query file 208. Upon accessing a schedule file 206, processor 111 will execute the required query, or queries, in schedule file 206 and/or the backlog at the frequency and for the duration specified. In embodiments where a “scheduled runner” test is being performed, connection line 498 is to be omitted from FIG. 4. That is, after executing a query, or queries, in schedule file 206 and/or the backlog, processor 111 will not move to step 430; rather, processor 111 will move directly to step 440. In embodiments where a “stress test runner” test is being performed, connection line 499 is to be omitted from FIG. 4. That is, after executing a query in SQL query file 208, processor 111 will not move to step 440; rather, processor 111 will move directly to step 430. In some embodiments, processor 111 may only simultaneously execute a number of queries up to the number of available processing threads. For example, if four processing threads are available, four queries may be executed simultaneously. That is, multiple scripts, or queries, may be executed in parallel to one another by utilising different threads of processor 111 as specified by thread number 216, for example.

In some embodiments, processor 111, when running a “stress test runner” test, may only loop through the SQL query file 208 a number of times as specified by batch number 218. In some embodiments, if the prepare option 228 is configured during execution of performance test module 122, then prior to processor 111 performing step 420 for a “stress test runner” test, processor 111 may prepare (compile) the SQL script prior to execution. In some embodiments, compiling the script prior to execution may significantly increase throughput. In some embodiments, the frequency at which the queries for the “scheduled runner” test are run may be scaled dependent on scale factor 230 as previously described. In some embodiments, processor 111 may skip data-modifying queries if the ignore writes 234 setting is enabled. If the ignore writes 234 setting is not enabled then the allow writes 232 setting will be enabled, allowing processor 111 to execute data-modifying queries.

In some embodiments, queries executed by processor 111 when performing a “scheduled runner” test may utilise the parameter cache 240 to simulate active tenant workload. The number of active tenants available from parameter cache 240 is specified by working set 236. In some embodiments, working set 236 may be dynamically changed by scale factor 230 in combination with ramp 248 to simulate an increase over time in load on database system 140.

At step 440, processor 111 will determine whether a termination of method 400 is required. This may occur in one of two ways. The first may be if a data value for duration 220 was provided, either manually as user input or within performance test settings 126 prior to execution of performance test module 122. In this case, processor 111 will determine whether the specified duration has passed for the current test. If the specified duration stored within duration 220 has passed, processor 111 will stop looping through steps 420, 425, 430, 435, and 440, and move to step 445. The second method for termination is manual termination of method 400 by a user. That is, processor 111 will check whether manual termination of the test has occurred. In some embodiments, manual termination of the test may occur during any of the steps of method 400. That is, if at any time manual termination is provided via user I/O 112, processor 111 will stop executing its current step and move to step 445. At step 440, if termination of method 400 has not occurred, processor 111 will continue to execute method 400 at step 420. That is, if termination of method 400 has not occurred, processor 111 will loop through steps 420, 425, 430, 435, and 440, as previously described.

In some embodiments, while processor 111 is performing steps 420, 425, 430, 435, and 440, processor 111 may also intermittently sample performance test data 127 dependent on the time specified in performance sample interval 212. Processor 111 may also output the performance test data 127 dependent on the time specified in the flush time interval 214. In some embodiments, while processor 111 is performing steps 420, 425, 430, 435, and 440, processor 111 may also intermittently sample performance statistics 128 dependent on the time specified in performance period 254. Processor 111 may also output the performance statistics 128 dependent on the time specified in performance flush 256 to a file as indicated by performance stats 252.

At step 445, after completion of the performance test conducted on database system 140, processor 111, executing performance test module 122, records and outputs the performance test data 127 as described above in relation to FIG. 3. According to some embodiments, only a subset of the data described with respect to FIG. 3 may be output. In some embodiments, the output of this data may be stored in a separate file for each test performed. The performance test data 127 output may be a file named as directed by output name 210. Performance test data 127 may be configured according to test name 244 and no header 246 as previously described. In some embodiments, if the errors 250 setting is specified, an error file may be output by processor 111 during step 445. At step 450, processor 111 stops executing performance test module 122 and method 400.

In some embodiments, if help option 222 is provided during execution of performance test module 122, processor 111 at step 405 may directly move to step 455. At step 455, processor 111 will display a help menu to the user which may include setting explanations, instructions, and answers to frequently asked questions. Upon receiving input from the user to exit the help menu via user I/O 112, processor 111 may continue executing method 400 at step 410. In some embodiments, information relating to performance test module 122 may be displayed on user I/O at an FPS specified in frames per second 258. In some embodiments, this information relating to performance test module 122, may be a graphical user interface allowing simple user interaction with performance test module 122, for example.

In some embodiments, a “scheduled runner” test may be used to optimise or tune queries. That is, two or more variations of the same query may be scheduled to run with the same parameters in schedule file 206, for example. Performance test data 127 may then be compared to optimise the particular queries tested and determine which query performed better. In some embodiments, either the “stress test runner” test or the “scheduled runner” test may be used to identify bottlenecks in server system 130, querying device 110, or network 150. That is, in execution of method 400, a backlog of queries to be run to get up to date may be recorded. If the number of queries in the backlog increases, this is indicative of a bottleneck in at least one of the server system 130, querying device 110, or network 150. Performance statistics 128 and performance test data 127 may then be analysed to identify where the bottleneck has occurred, for example.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for conducting a performance test on a database system, the method comprising:
receiving a plurality of configuration options, the configuration options determining parameters of the performance test to be conducted;
retrieving organisation data from the database system to be tested;
performing a plurality of query operations on the database system, the plurality of query operations being based at least in part on the plurality of configuration options and the-retrieved organisation data; and
recording database performance data based on the performance of the performed query operations.

2. The method of claim 1, wherein the configuration options include at least one query to be executed and at least one frequency at which the query is to be executed.

3. The method of claim 2, wherein performing a plurality of query operations on the database system comprises identifying whether at least one query is scheduled to be performed based on the at least one frequency, and upon determining that at least one query is scheduled to be executed, executing the query.

4. The method of claim 3, further comprising upon determining that no queries are scheduled to be executed, causing a thread to sleep for a predetermined duration.

5. The method of claim 1, wherein the organisation data comprises data related to an amount of data stored by an organisation in the database system being queried.

6. The method of claim 5, wherein the organisation data comprises data related to a rank of the organisation based on the amount of data stored by the organisation in the database system being queried.

7. The method of claim 1, wherein at least two of the plurality of query operations are performed simultaneously.

8. The method of claim 1, wherein the database system is a sharded database and the method is performed for each shard.

9. The method of claim 1, wherein the plurality of query operations are the same.

10. The method of claim 9, wherein the plurality of query operations are performed repeatedly at a same frequency.

11. The method of claim 9, wherein the plurality of query operations are performed at varying frequencies.

12. The method of claim 1, wherein the plurality of configuration options are retrieved from an SQL file.

13. The method of claim 1, further comprising, after receiving the plurality of configuration options, validating the plurality of configuration options.

14. The method of claim 13, wherein validating the plurality of configuration options comprises checking that at least one query has been received.

15. The method of claim 13, wherein validating the plurality of configuration options comprises checking that at least one frequency has been received.

16. The method of claim 1, further comprising:
storing a plurality of overdue query operations in a backlog; and
wherein the stored plurality of overdue query operations are prioritised.

17. A device comprising:
a memory storing executable code;
a processor configured to access memory to execute the executable code; and
wherein when executing the executable code, the processor is caused to perform operations including:
receiving a plurality of configuration options, the configuration options determining parameters of a performance test to be conducted;
retrieving organisation data from a database system to be tested;
performing a plurality of query operations on the database system, the plurality of query operations being based at least in part on the plurality of configuration options and the retrieved organisation data; and
recording database performance data based on the performance of the performed query operations.

18. A non-transient computer-readable storage medium storing instructions that, when executed by a processor, cause the processor to perform operations including:
receiving a plurality of configuration options, the configuration options determining parameters of a performance test to be conducted;
retrieving organisation data from a database system to be tested;
performing a plurality of query operations on the database system, the plurality of query operations being based at least in part on the plurality of configuration options and the retrieved organisation data; and
recording database performance data based on the performance of the performed query operations.

19. The device of claim 17, wherein the configuration options include at least one query to be executed and at least one frequency at which the query is to be executed.

20. The non-transient computer-readable storage medium of claim 18, wherein the configuration options include at least one query to be executed and at least one frequency at which the query is to be executed
